(19) United States
(12) Patent Application Publication
(10) Pub. No.: US 2016/0085119 A1
(43) Pub. Date: Mar. 24, 2016

(54) LIQUID CRYSTAL DISPLAY DEVICE AND MATERIAL FOR ALIGNMENT FILM

(71) Applicant: Japan Display Inc., Tokyo (JP)

(72) Inventors: Takenori HIROTA, Tokyo (JP); Yosuke HYODO, Tokyo (JP); Noboru KUNIMATSU, Tokyo (JP); Yasushi TOMIOKA, Tokyo (JP); Hidehiro SONODA, Tokyo (JP)

(21) Appl. No.: 14/858,821

(22) Filed: Sep. 18, 2015

(30) Foreign Application Priority Data
Sep. 19, 2014 (JP) 2014-191318
Jun. 11, 2015 (JP) 2015-118453

(51) Int. Cl. G02F 1/1337

(52) U.S. Cl. CPC G02F 1/133788; G02F 1/133719

(57) ABSTRACT

A liquid crystal display device including an alignment film which has been optically aligned is configured that the liquid crystal has negative dielectric anisotropy, an absolute value of which is equal to or smaller than 5. The alignment film is subjected to an optical alignment process to exhibit the optical alignment property, and includes a first film located at a side in contact with the liquid crystal, and a second film below the first film, which is not optically aligned to have no alignment property. The alignment film is formed by applying a mixture of a first material for forming the first film and a second material for forming the second film to the substrate. The first material for the alignment film accounts for 10 wt. % or more and less than 40 wt. % of a total weight of the first and the second materials.

### CLAIM OF PRIORITY

The present application claims priority from Japanese Patent Application JP 2014-191318 filed on Sep. 19, 2014 and Japanese Patent Application JP 2015-118453 filed on Jun. 11, 2015, the content of which is hereby incorporated by reference into this application.

### BACKGROUND OF THE INVENTION

(1) Field of the Invention

The present invention relates to a display device, and more particularly, to a liquid crystal display device having an optically aligned alignment film.

(2) Description of the Related Art

The liquid crystal display device is configured to include a TFT substrate in which pixels each having a pixel electrode and a thin film transistor (TFT) are arranged in a matrix, and a counter substrate facing the TFT substrate so that liquid crystal is interposed between the TFT substrate and the counter substrate. The optical transmittance is controlled by the liquid crystal molecules for each pixel so as to form an image.

The liquid crystal display device is required to perform initial alignment of the liquid crystal by means of the alignment film. Generally, the rubbing method has been employed for the alignment process using the alignment film. The rubbing method, however, has caused problems, for example, the bright spot generated by the chip from the alignment film shaved during rubbing, dielectric breakdown of wiring owing to static electricity generated during rubbing. On the contrary, the optical alignment process is executed by cutting the polymer chain in a given direction through polarized UV to impart the uniaxial magnetic anisotropy to the alignment film. This process hardly suffers the problems caused by the rubbing process, which has been widely distributed.

Meanwhile, the liquid crystal display device has a viewing angle feature as a problem to be overcome. The viewing angle feature represents the phenomenon that makes the luminance or chromaticity of the screen different between viewing angles at which the screen is viewed from the front and the screen is viewed obliquely. IPS (In Plane Switching) process may provide excellent viewing angle feature by driving liquid crystal molecules in the horizontal electric field. The IPS type requires no setting of the pre-tilt angle, which is especially suitable for the optical alignment.

Japanese Unexamined Patent Application Publication No. 2009-288298 discloses the structure for preventing generation of an afterimage by means of the alignment film having polyamic acid ester as the precursor for the optical alignment. WO2011/115078 discloses the structure in which fine irregularities of the surface of an alignment film derived from laminating an alignment film having polyamic acid ester as the precursor, and another alignment film having polyamic acid as the precursor is suppressed by making the weight-average molecular weight of polyamic acid ester smaller than that of polyamic acid. WO2011/114103 discloses an example of the imidizing accelerator for assisting formation of the alignment film.

### SUMMARY OF THE INVENTION

The liquid crystal employed for the liquid crystal display device has two types, that is, positive type and negative type. The positive type liquid crystal has the positively set dielectric anisotropy Δ∈ of the liquid crystal molecule, and the negative type liquid crystal has the negatively set dielectric anisotropy Δ∈ of the liquid crystal molecule. In other words, the positive type liquid crystal has the major axis of the liquid crystal molecule directed to the electric field, and the negative type liquid crystal has the minor axis of the liquid crystal molecule directed to the electric field.

For example, the liquid crystal display device of IPS type is configured that the liquid crystal molecule rotates along the electric field direction to control the optical transmittance for each pixel so as to form an image. The display region may have a section on which reverse rotation occurs in the pixel depending on the configuration of the pixel electrode or the counter electrode. The thus generated section is called disclination, which will not allow optical transmission. As a result, the luminance of the screen is deteriorated to lower the contrast. The positive type liquid crystal is likely to cause disclination especially at the end of the electrode pattern.

Another problem of the positive type liquid crystal is that the liquid crystal molecule is likely to rise in the normal direction of the substrate upon pressing of the surface of the liquid crystal display panel. The aforementioned rising of the liquid crystal molecule tends to occur in the section where disclination has occurred. The liquid crystal display device of IPS type is liable to have blur on the screen owing to the rising of the liquid crystal molecule as described above.

Meanwhile, compared to the positive type liquid crystal, the negative type liquid crystal is unlikely to have problems as described above. Therefore, the negative type liquid crystal is used to satisfy the requirement of the liquid crystal display device to prevent especially disclination. However, use of the negative type liquid crystal may lower the voltage holding rate. The voltage holding rate is used for evaluating as to what extent the voltage of the signal entered into the pixel is held until the next entry of the signal voltage.

In the case where the liquid crystal display device is driven at the low frequency while having the low voltage holding rate for suppressing power consumption, flicker occurs in the display region. The locally lowered voltage holding rate may cause unevenness in the display region of the screen. The present invention is intended to prevent flicker and unevenness of the screen owing to the lowered voltage holding rate in operation of the liquid crystal display device configured to use the negative type liquid crystal for optically aligning the alignment film.

The present invention will be described as follows.

(1) The liquid crystal display device includes liquid crystal between a first substrate provided with an alignment film and a second substrate provided with an alignment film. The liquid crystal has negative dielectric anisotropy, an absolute value of which is equal to or smaller than 5. The alignment film is subjected to a polarized UV optical alignment process. The alignment film includes a first film that is optically aligned to have alignment property, located at a side in contact with the liquid crystal, and a second film that is not optically aligned to have no alignment property, located at a side of the first or the second substrate. The alignment film is formed by applying a mixture of a first material for forming the first film and a second material for forming the second film to the first substrate or the second substrate. The first material accounts for 10 wt. % or more and less than 40 wt. % of a total weight of the first material and the second material.
(2) In the liquid crystal display device according to (1), the first material is polyamic acid ester expressed by a chemical formula 1, and the second material contains polyamic acid.

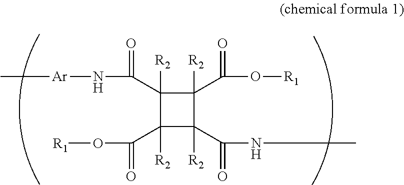

Referring to the chemical formula (1), R1 denotes independent 1-8C alkyl groups, and R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0,1,2) or alkynyl group (—(CH₂)m-C≡CH, m=0,1,2), and Ar denotes aromatic compound.

(3) In the liquid crystal display device according to (1) or (2), the first material is polyamic acid ester. The polyamic acid ester is formed by a first diamine as a precursor. A chemical structure of the first diamine contains an aromatic ring but does not contain nitrogen atom except the one in two amino groups, fluorine atom, and oxygen atom.
(4) In the liquid crystal display device according to any one of (1) to (3), the second material is polyamic acid. The polyamic acid is formed by a second diamine as a precursor. A chemical structure of the second diamine contains nitrogen atom except the one in two amino groups, fluorine atom, or oxygen atom.
(5) In the liquid crystal display device according to any one of (1) to (4), the mixture contains an imidizing accelerator. A chemical structure of the imidizing accelerator contains secondary or tertiary amines with picoline, quinolone, isoquinoline or pyridine skeleton, or amino acid with alkoxycarbonyl group.

### BRIEF DESCRIPTION OF THE DRAINWGS

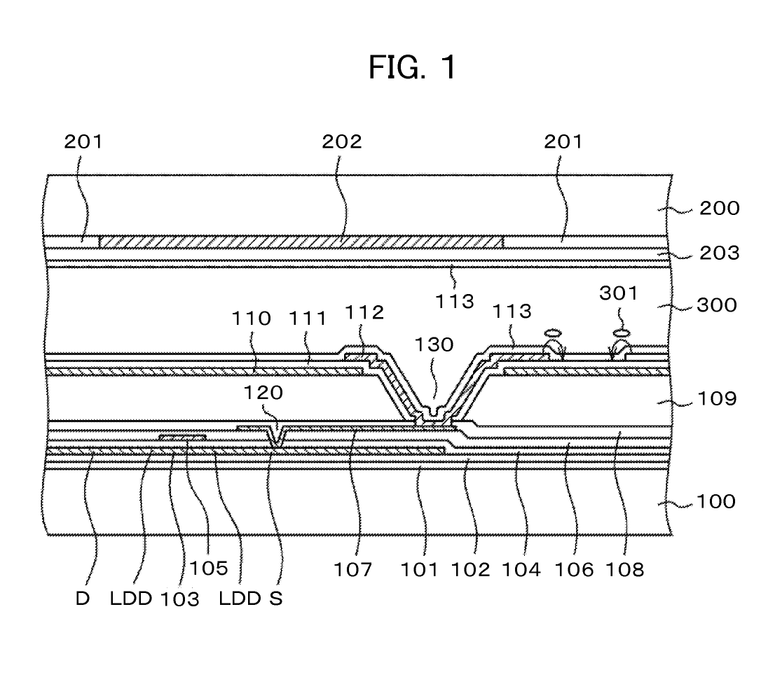

FIG. 1 is a sectional view of a liquid crystal display device to which the present invention is applied;

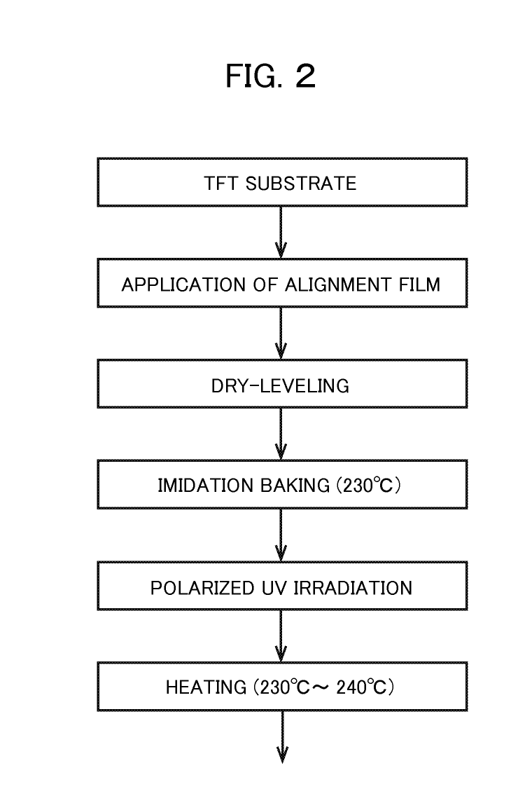

FIG. 2 is a flowchart representing the optical alignment process;

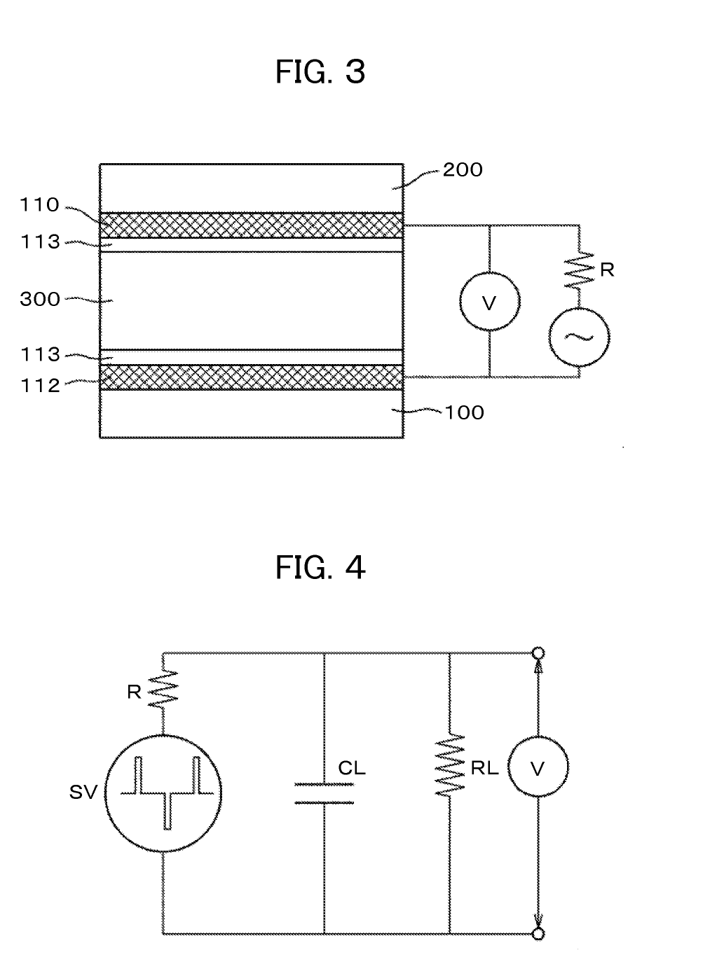

FIG. 3 is a view representing a circuit for measuring the voltage holding rate;

FIG. 4 is a view representing an equivalent circuit for measuring the voltage holding rate;

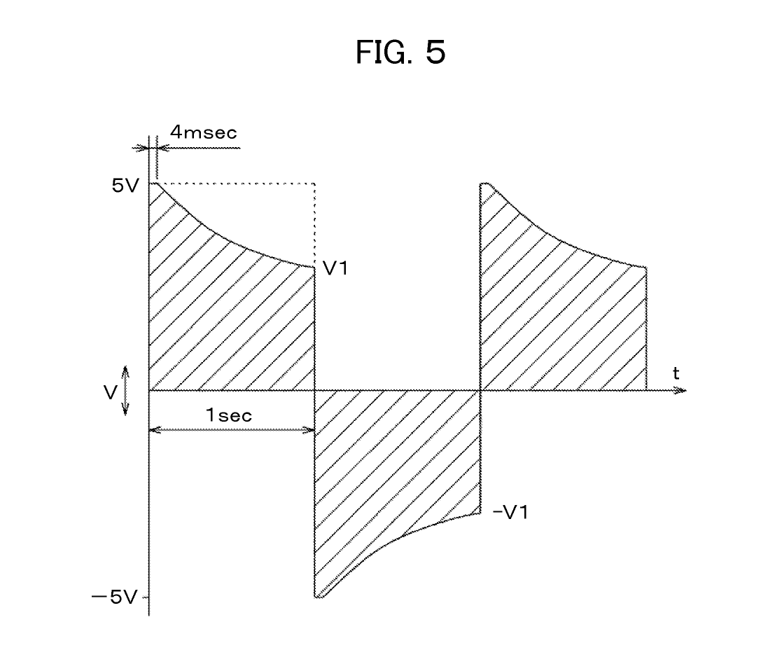

FIG. 5 is a view representing changes in potential of one of electrodes of a test cell;

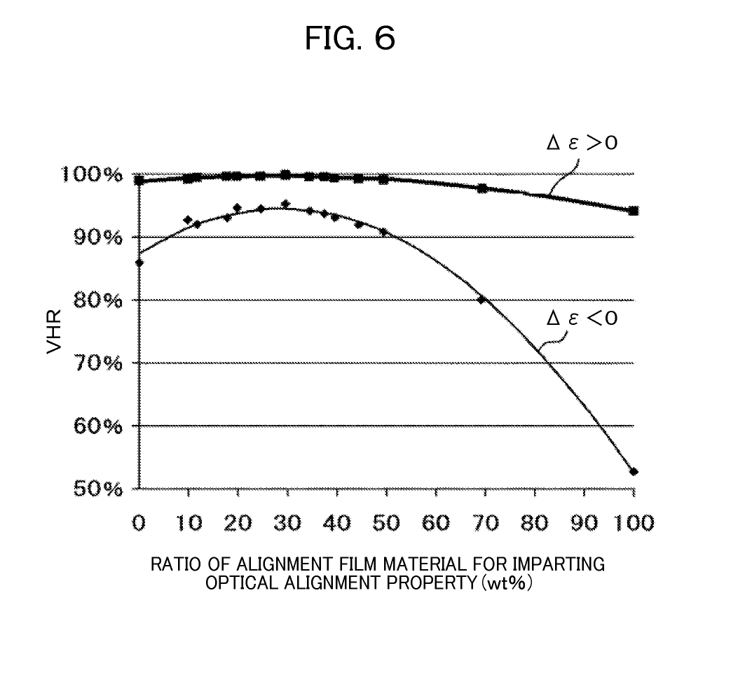

FIG. 6 is a graph representing a relationship between the voltage holding rate and the ratio of a first material for forming a first film to be optically aligned to a second material for forming a second film not to be optically aligned;

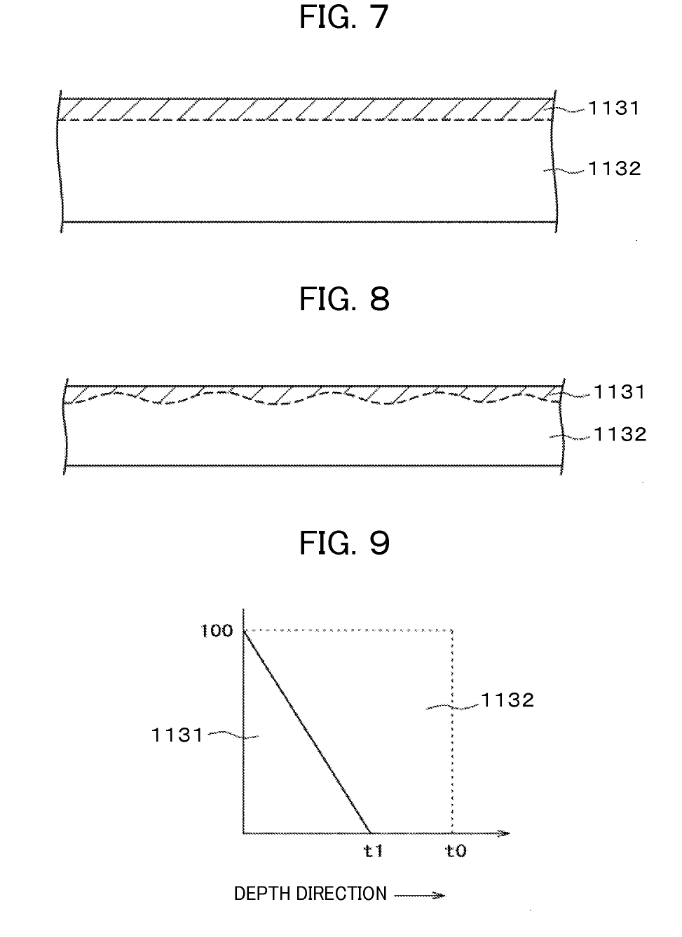

FIG. 7 is a schematic sectional view of a 2-layer alignment film;

FIG. 8 is a sectional view of an actual 2-layer alignment film;

FIG. 9 is a graph representing an example of a ratio of the first material for forming the first film to be optically aligned to the second material for forming the second film not to be optically aligned with respect to the depth direction of the alignment film; and

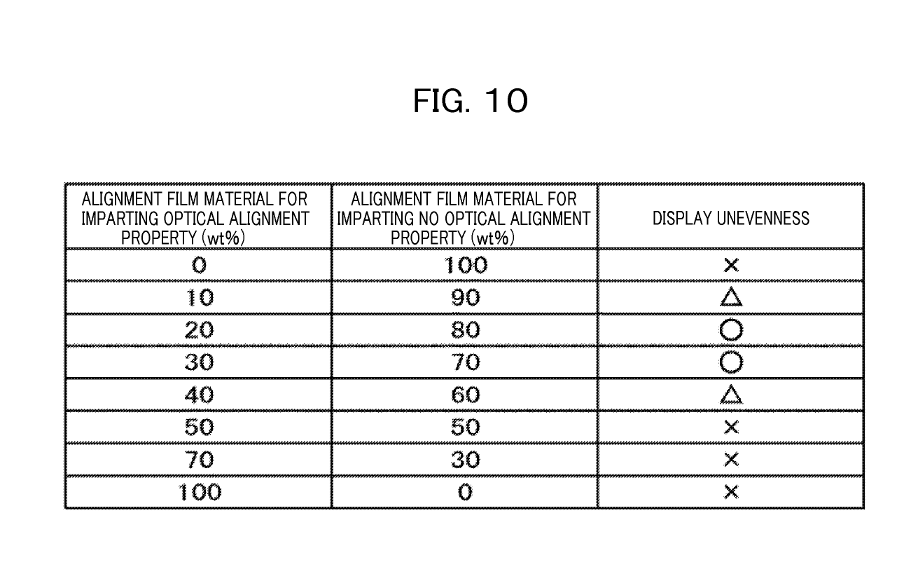

FIG. 10 represents a relationship between display unevenness and a ratio of the first material for forming the first film to be optically aligned to the second material for forming the second film not to be optically aligned.

### DETAILED DESCRIPTION OF THE PREFERRED EMBODIMENTS

The present invention will be described in detail in reference to an embodiment as described below.

### First Embodiment

The present invention is generally applicable to the liquid crystal display device which employs the optical alignment process. The present invention will be described by taking the liquid crystal display device of IPS type as an example. It is also possible to employ the liquid crystal display device of TN (Twisted Nematic) type, and VA (Vertical Alignment) type.

FIG. 1 is a sectional view of the liquid crystal display device of IPS type. The TFT shown in FIG. 1 is so called a top gate type TFT using LTPS (Low Temperature Poly-Silicon) semiconductor. On the other hand, the a-Si semiconductor is used for so called bottom gate type TFT in most cases. The following explanation will be made on the assumption that the top gate type TFT is used. However, it is possible to apply the present invention to the case using the bottom gate type TFT.

Referring to FIG. 1, a first base film 101 formed of SiN and a second base film 102 formed of SiO₂ are applied onto a glass substrate 100 through CVD (Chemical Vapor Deposition) process. The first base film 101 and the second base film 102 serve to protect a semiconductor layer 103 from contamination by impurities from the glass substrate 100.

The semiconductor layer 103 is formed on the second base film 102 by forming the a-Si film on the second base film 102 through the CVD process, and laser annealing the thus formed film so as to be converted into a poly-Si film. The poly-Si film is patterned by photolithography.

Applied onto the semiconductor film 103 is a gate insulation film 104 in the form of SiO₂ film as TEOS (tetraethoxysilane) formed through the CVD process, on which a gate electrode 105 is formed. A scanning line serves for the gate electrode 105. The gate electrode 105 is formed from a MoW (molybdenum, tungsten) film, for example. An Al alloy may be used to lower resistance of the gate electrode 105 or the scanning line 10.

The gate electrode 105 is patterned by photolithography. During the patterning, the impurity such as phosphorus and boron is doped to the poly-Si layer through ion implantation so that the source S or drain D is formed on the layer. An LDD (Lightly Doped Drain) layer is formed between a channel layer of the poly-Si layer and the source S or the drain D using the photoresist while patterning the gate electrode 105.

Then a first interlayer insulation film 106 which covers the gate electrode 105 is formed from SiO₂ for insulating the gate electrode 105 and a contact electrode 107. A through hole 120 is formed in the first interlayer insulation film 106 and the gate insulation film 104 for connecting the source S of the semiconductor layer 103 to the contact electrode 107. The photolithography is carried out for forming the through hole 120 in the first interlayer insulation film 106 and the gate insulation film 104 simultaneously.

The contact electrode 107 formed on the first interlayer insulation film 106 is connected to a pixel electrode 112 via a through hole 130. The drain D of the TFT is connected to a video signal line via a through hole at a not shown part.

The contact electrode 107 and the video signal line (hereinafter referred to simply as the contact electrode 107) are simultaneously formed to constitute the same layer. AlSi alloy is used for lowering the resistance. However, use of the AlSi alloy may cause hillock, and diffuse Al to the other layer. In order to cope with the problem, the AlSi alloy is sandwiched between a barrier layer and a cap layer (not shown) formed from MoW material.

The contact electrode 107 and the TFT are coated with an inorganic passivation film (insulation film) 108 for protective purpose. Likewise the first base film 101, the inorganic passivation film 108 is formed through the CVD process. For example, silicon nitride or silicon oxide is used for forming the inorganic passivation film 108. An organic passivation film 109 is formed to cover the inorganic passivation film 108. The organic passivation film 109 is formed from a photosensitive acrylic resin. Besides the acrylic resin, silicone resin, epoxy resin, polyimide resin and the like may be used for forming the organic passivation film 109. The organic passivation film 109 has a large thickness so as to provide the function as a flattening film. The thickness of the organic passivation film 109 is in the range from 1 to 4 μm, and in most cases, approximately 2 μm.

In order to obtain electric conduction between the pixel electrode 110 and the contact electrode 107, the through hole 130 is formed both in the inorganic passivation film 108 and the organic passivation film 109. In the case where the photosensitive resin used for forming the organic passivation film 109 is exposed to exposure light after application of such photosensitive resin, the light receiving part is only dissolved in the specific developing fluid. That is, use of the photosensitive resin may eliminate the process of forming the photoresist. The organic passivation film 109 is finally produced by forming the through hole 130 therein, and carrying out baking at approximately 230° C.

The ITO (Indium Tin Oxide) to be formed into the common electrode 110 is produced through sputtering, and patterned to remove the ITO from the through hole 130 and its periphery. This makes it possible to form the common electrode 110 into planar shape commonly for the respective pixels. The SiN is applied over the entire surface to produce a second interlayer insulation film 111 through the CVD process. Then the through hole is formed in the second interlayer insulation film 111 and the inorganic passivation film 108 for obtaining electric conduction between the contact electrode 107 and the pixel electrode 112 in the through hole 130. The ITO is produced through sputtering, which is patterned to form the pixel electrode 112.

An alignment film 113 is formed by applying the alignment film material onto the pixel electrode 112 through flexographic printing or ink jet printing, and baking the applied material. According to the present invention, the alignment film is subjected to polarized UV process. Therefore, the alignment film material suitable for optical alignment is employed. Various types of optical alignment methods have been proposed. In the case of the optical alignment film of photodimerizing type, the alignment process is carried out by irradiating the polarized UV containing wavelength of 313 nm at the intensity of 100 mJ/cm². In the case of the optical alignment film of optical isomerizing type, the alignment process is carried out by irradiating the polarized UV containing wavelength of 365 nm at the intensity of 200 mJ/cm². In the case of the optical alignment film of so called photodecomposition type, the alignment process is carried out by irradiating the polarized UV containing wavelength of 254 nm at the intensity of 1000 mJ/cm².

FIG. 2 is a flowchart representing the process for forming the optical alignment film of photodecomposition type. Referring to FIG. 2, the process includes steps of applying the alignment film to the TFT substrate, drying, and leveling the film. In the leveling step, the alignment film is flattened. Thereafter, the alignment film is imidized at high temperature of 200° C. or higher. The polarized UV is then irradiated to impart uniaxial anisotropy to the alignment film. The film is further heated at high temperature to vaporize remaining monomer and oligomer. The present invention employs the first material to be optically aligned and the second material not to be optically aligned for forming the alignment film. The optical alignment process is carried out in the similar manner to the one as described above.

Referring back to FIG. 1, application of voltage between the pixel electrode 112 and the common electrode 110 generates the electric line of force as shown in FIG. 1. The resultant electric field rotates the liquid crystal molecule 301 to control intensity of the light transmitting through a liquid crystal layer 300 for each pixel so as to form the image.

As FIG. 1 shows, the counter electrode 200 is disposed while interposing the liquid crystal layer 300 with the TFT substrate. A color filter 201 is formed on the inner surface of the counter substrate 200. The color filter 201 includes red, green and blue color filters for each of the pixels so that a color image is generated. A light shielding film 202 is interposed between the color filters 201 for improving the image contrast. The light shielding film 202 may be configured with no limitation. However, it is preferable to be configured in a matrix.

An overcoat film 203 is formed to cover the color filter 201 and the light shielding film 202. The overcoat film 203 serves to flatten irregular surfaces of the color filter 201 and the light shielding film 202. The alignment film 113 is formed on the overcoat film so that the initial alignment of the liquid crystal is determined. The alignment film 113 is subjected to the alignment process in the similar manner to the one carried out for the alignment film 113 formed at the side of the TFT substrate 100 as described referring to FIG. 2.

The above structure has been described as an example. It is to be understood that a certain type of the liquid crystal display device may have no inorganic passivation film 108 applied to the TFT substrate 100, or the different process for forming the through hole 130 may be used.

Unlike the rubbing method case, a part of the optically aligned alignment film, which allows UV transmission is subjected to the alignment process. The alignment film of photodecomposition type, if any, will be decomposed by UV, thus weakening the film strength. The deteriorated film strength will bring the initial alignment of the liquid crystal into unstable, leading to an afterimage phenomenon, for example.

The present invention provides the alignment film with 2-layer structure formed of a first film to be optically aligned and a second film not to be optically aligned so as to establish both the liquid crystal alignment property and the film strength. The alignment film with 2-layer structure is formed by applying a mixture of polyamic acid ester expressed by a chemical formula 1 and polyamic acid expressed by a chemical formula 2 as the material for forming the alignment film.

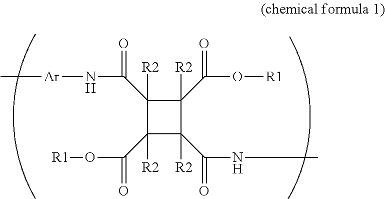

Referring to the chemical formula 1, R1 denotes independent 1-8C alkyl groups, and R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0,1,2) or alkynyl group (—(CH₂)m-C≡CH, m=0,1,2), and Ar denotes aromatic compound.

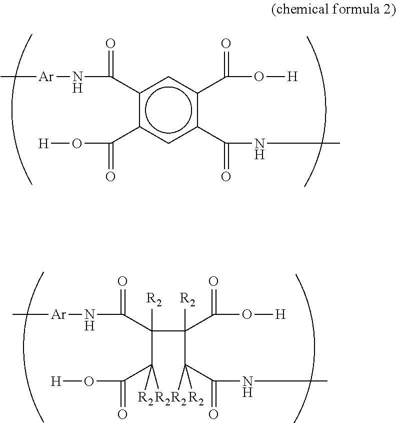

Referring to the chemical formula 2, R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0, 1, 2) or alkynyl group (—(CH₂)m-C≡CH, m=0, 1, 2), and Ar denotes aromatic compound.

Unlike the chemical formula 1, the chemical formula 2 has no cyclobutane skeleton, which is unlikely to be influenced by UV. The chemical formula 2 is different from the chemical formula 1 in that H replaces R1 of the formula 1 representing polyamic acid ester.

Upon application of the material for forming the alignment film as the mixture of compounds expressed by the chemical formulae 1 and 2, the film is separated into the first material to be optically aligned, having polyamic acid ester as precursor at the upper side (liquid crystal side), and the second material not to be optically aligned, having polyamic acid as precursor at the lower side.

It has been found that the upper and lower layers of the alignment film are not clearly separated from the boundary therebetween. In other words, existence of component distribution has been revealed, which allows gradual increase in the upper alignment component from the lower side. Preferably, the distribution is formed to completely cover the outermost surface with the component to be optically aligned. Actually, however, the lower alignment film component exists to a certain degree, which is not optically aligned at several millimeters from the outermost surface. In other words, the first film at the side in contact with the liquid crystal and the second film that exists at the side of the second substrate are not formed as clearly separated films.

The polyamic acid expressed by the chemical formula 2 has been described as an example. It is possible to use polyamic acid with other structure so long as it can be mixed with polyamic acid ester, and after application of the mixture, it is separated from polyamic acid ester to be located as the lower layer.

Recently, the liquid crystal display device has been configured to allow the drive circuit to perform low frequency driving (frequency at 20 kHz or lower) or intermittent driving for still image display so as to reduce power consumption. Upon low frequency driving or intermittent driving (hereinafter referred to simply as low frequency driving), the voltage holding rate of the pixel in the signal entry interval is essential. If the signal entry interval is prolonged, the leakage may lower the pixel potential. The reduced resistivity of the liquid crystal becomes major cause of such leakage. Fluctuation in the pixel potential in the signal entry interval will cause flickering. Leakage owing to local accumulation of impurities in the liquid crystal will locally change the luminance, resulting in luminance unevenness. It is therefore important to keep the resistivity of the liquid crystal and the high voltage holding rate for displaying high quality image.

In the case where the first film that has been optically aligned is formed as the upper layer, and the second film that has not been optically aligned is formed as the lower layer, the voltage holding rate of the pixel electrode for the liquid crystal display device changes in accordance with the ratio between the material for forming the first film to be optically aligned and the material for forming the second film not to be optically aligned. The voltage holding rate is significantly influenced by the liquid crystal resistivity.

FIG. 3 is a schematic view showing a voltage holding rate measurement circuit. Referring to FIG. 3, the electrode 112 is formed on the lower substrate 100 of a test cell, on which the alignment film 113 is formed. The electrode 110 is formed on the upper substrate 200, on which the alignment film 113 is formed. Both the electrodes 112 and 110 are produced through the ITO process likewise the pixel electrode or the common electrode. The liquid crystal is interposed between the upper substrate and the lower substrate.

Referring to FIG. 3, upon application of AC voltage between the electrodes 112 and 110, the voltage holding rate (VHR) is determined in accordance with the voltage V between the upper and the lower electrodes. As the power supply has an internal resistance R, the voltage V is reduced as the resistance of the liquid crystal is lowered. If the resistance is lowered by ingress of impurities in the liquid crystal, the voltage V drops accordingly. The voltage holding rate will also be reduced by deterioration in the liquid crystal owing to long-time operation. Reduced voltage holding rate will result in the flickering and luminance unevenness on the screen.

The voltage holding rate represented by FIG. 3 is variable in accordance with waveform of the applied voltage and the measurement temperature. The voltage holding rate herein is determined in accordance with the voltage V applied as shown in FIG. 4. Referring to FIG. 4, SV denotes the waveform of the power voltage, R denotes the internal resistance of the power supply, CL denotes liquid crystal capacitor, and RL denotes the leakage resistance of liquid crystal. As the leakage resistance RL becomes small, the voltage V drops, which is likely to generate flickering. The waveform SV of the power supply shown in FIG. 4 is intended to apply the pulse in a specific cycle.

FIG. 5 represents change in the voltage of one of the electrodes of the test cell upon application of the power supply waveform of the circuit shown in FIG. 4. Referring to FIG. 5, the power supply is configured to apply the pulse with width of 4 msec at 5V at the interval of 1 sec. The voltage of one of the electrodes of the test cell is kept 5 V during 4 msec pulse application, and thereafter, reduced in accordance with the time constant determined by the leakage resistance of the liquid crystal and the liquid crystal capacitor. After elapse of 1 sec subsequent to application of the first pulse, the pulse with width of 4 msec is applied at −5V. The positive and negative pulses are alternately applied for the purpose of testing under the condition close to the one for driving the liquid crystal.

As FIG. 5 shows, after application of the pulse voltage, the voltage of one of the electrodes of the test cell is lowered in accordance with the exponential function determined by the time constant. Assuming that there is no leakage in the liquid crystal, the electrode at one side of the test cell is kept at 5V as indicated by a dotted line of FIG. 5. The voltage holding rate is defined herein as the ratio of an area of the rectangular region indicating no voltage leakage, 1 sec×5V to an area of the shaded region shown in FIG. 5. In other words, the liquid crystal display device with less voltage leakage exhibits high voltage holding rate, thus suppressing flickering in the low frequency operation.

In other words, high resistance of the liquid crystal ensures higher voltage holding rate. The liquid crystal resistance is variable with various conditions. The present invention is configured to use the liquid crystal material with negative dielectric anisotropy, that is, negative type liquid crystal. The negative type liquid crystal is likely to exhibit lower resistance than the liquid crystal material with positive dielectric anisotropy, so called positive type liquid crystal because of its nature easy to take impurities in the liquid crystal.

In most cases, the optically aligned alignment film is decomposed by UV irradiation, and decomposed product is kept unvaporized under heat after UV irradiation, thus being left as residue. Ingress of the residue in the negative type liquid crystal will lower the liquid crystal resistance, thus increasing the voltage leakage. In the case of alignment film with 2-layer structure, the first film to be optically aligned is disposed at the upper layer, and the second film not to be optically aligned is disposed at the lower layer.

The first film to be optically aligned is decomposed by UV, and the probability that the decomposed product is left unvaporized will become higher. Meanwhile, decomposition of the second film not to be optically aligned by UV is significantly less than the optically aligned first film. The resultant decomposed product is far less than that of the optically aligned first film. The inventor has discovered that the liquid crystal resistance is variable with the ratio of the optically aligned material to the material for forming the alignment film with 2-layer structure. In other words, the voltage holding rate will vary with such ratio.

FIG. 6 is a graph showing variation in the voltage holding rate as described above. Referring to FIG. 6, the x-axis denotes the rate of the alignment film material for forming the one to be optically aligned to the alignment film material with 2-layer structure, and the y-axis denotes the voltage holding rate (VHR). In this case, the measurement temperature was kept at 60° C. The mixture of polyamic acid ester (first material) expressed by the chemical formula 1, and polyamic acid (second material) expressed by the chemical formula 2 was used as the alignment film material. Therefore, the x-axis of FIG. 6 denotes the ratio of the polyamic acid ester.

FIG. 6 represents changes in the voltage holding rate in two cases of positive anisotropy ∈ and negative anisotropy ∈ of the liquid crystal. As FIG. 6 clearly shows, in the case of positive ∈, dependency of the voltage holding rate on the ratio of the polyamic acid ester (PE) is significantly low. Meanwhile, in the case of negative ∈, dependency of the voltage holding rate on the ratio of the polyamic acid ester (PE) is significantly high. As the ratio of the polyamic acid ester becomes larger, the voltage holding rate is lowered.

Specifically, the alignment film having polyamic acid ester as the precursor will generate the residue of the decomposed product after UV irradiation as a result of optical alignment to the alignment film. As the negative liquid crystal is more likely to take the residue therein, the liquid crystal resistance becomes lower because it is considered that amount of the residue becomes larger as increase in the polyamic acid ester.

It has been found that the negative type liquid crystal having the absolute value |∈| of dielectric anisotropy equal to or smaller than 5 becomes unlikely to take impurities in the liquid crystal. If the amount of impurity in the liquid crystal is small, the liquid crystal resistance may be kept high, preventing reduction in the voltage holding rate. In the present invention, it is preferable to use the negative type liquid crystal with the absolute value |∈| equal to or lower than 5.

The outermost surface layer of the alignment film with a certain thickness serves to align the liquid crystal. That is, it is sufficient to optically align especially the outermost surface of the alignment film. As FIG. 7 shows, it will be the most efficient by forming an alignment film 1131 having polyamic acid ester as precursor to be optically aligned as the outermost surface, below which an alignment film 1132 having polyamic acid as precursor subjected not to be optically aligned is formed as a main film body. Referring to FIG. 7, the shaded part denotes the region where a large amount of decomposed products are generated as a result of optical alignment.

The film to be optically aligned will be decomposed to the level which allows arrival of polarized UV. The decomposition is increased in proportional to irradiation of polarized UV as well as the residue. The residue may be reduced by allowing only the thin film as the outermost layer to be optically aligned. It is therefore possible to lessen generation of the residue as a result of polarized UV irradiation while maintaining the liquid crystal alignment property.

Actually, however, in the alignment film with 2-layer structure, each film does not have uniform thickness, and those films are not clearly separated with respect to the boundary. In other words, the component distribution exists both in the planar direction and the depth direction. FIG. 8 is a sectional view of the alignment film showing an example that the rate of the first film to be optically aligned changes depending on the location. Referring to FIG. 8, if the rate of the first film 1131 to be optically aligned is excessively reduced, the section with no alignment film to be optically aligned is generated. This may cause failure in the liquid crystal alignment depending on the location.

FIG. 9 is a graph representing a rate of the alignment film to be optically aligned in the depth direction. Referring to FIG. 9, the x-axis denotes the depth direction of the alignment film, and y-axis denotes a rate of the first film 1131 to be optically aligned. As shown in FIG. 9, the first film 1131 to be optically aligned constitutes the surface layer, and the second film 1132 not to be optically aligned exists, which is closer to the substrate than the first film 1131. As the depth of the alignment film reaches the value t1, the rate of the first film 1131 to be optically aligned becomes substantially zero. The thickness of the alignment film shown in FIG. 9 is designated as t0. FIG. 9 shows an example that only the first film to be optically aligned constitutes the whole surface of the alignment film. However, the amount of the first film is insufficient. If the rate of the alignment film to be optically aligned becomes smaller than the one shown in FIG. 9 even by the slight amount, alignment failure may occur.

FIG. 10 is a table representing evaluation on the relationship between the display unevenness and the ratio between the first material for forming the first film to be optically aligned and the second material for forming the second film not to be optically aligned, both of which constitute the alignment film. Referring to FIG. 10, the mark ◯ denotes the state where no display unevenness was observed, mark Δ denotes the state where the display unevenness was slightly observed, and mark X denotes the state where the display unevenness was observed.

As FIG. 10 represents, if the amount of the first material is excessively small, for example, 10 wt. % or less, the display unevenness occurs because of the alignment failure at the region of the outermost surface of the alignment film having no first film to be optically aligned. Meanwhile, if the amount of the material for forming the first film to be optically aligned is excessively large, 40 wt. % or more, the display unevenness occurs because of the lowered voltage holding rate as shown in FIG. 6.

As a result of evaluating the relationship between the voltage holding rate and the display unevenness in more detail referring to FIG. 6, it has been found that the voltage holding rate is allowed to reach 92% or higher so long as the ratio of the first material is in the range from 10 wt. % to 40 wt. %. This makes it possible to prevent generation of the display unevenness. Furthermore, generation of the display unevenness may be suppressed stably so long as the ratio of the first material for forming the alignment film to be optically aligned is equal to 18 wt. % or more, and less than 40 wt. %. Generation of the display unevenness may be suppressed reliably so long as the ratio of the first material for forming the first film is equal to 24 wt. % or more, and equal to 35 wt. % or less. FIG. 10 represents evaluation with respect to the display unevenness. As flickering occurs owing to the similar cause, the countermeasure may be taken for the flickering problem in the aforementioned manner.

Preferably, the alignment film material and the alignment film have the following material properties.

In the case where the alignment film is brought into contact with the seal material for bonding the TFT substrate 100 and the counter substrate 200, the alignment film is required to exhibit high film strength and high adhesive bonding strength to the seal material. In such a case, it is preferable to use silane coupling agent expressed by the chemical formula 3 or 4, or allow other additive to be added.

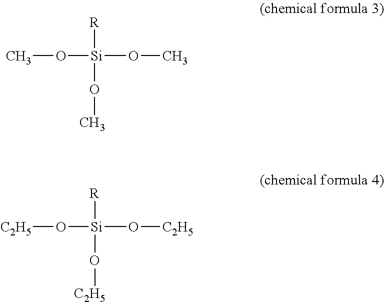

Preferably, the alignment film material contains an imidizing accelerator as another additive so as to facilitate imidization of polyamic acid and polyamic acid ester. After execution of the optical alignment process, the first film may be formed, which is suitable for the surface of the alignment film in contact with the liquid crystal. The imidizing accelerator is decomposed into fine molecules by the heating process or UV process in the course of forming the alignment film, which may in turn to become impurities that lower the liquid crystal resistance. Small quantity of such impurity may influence the liquid crystal resistance. Therefore, the imidizing accelerator is required to be selected in consideration of the imidizing acceleration effect and decomposition property.

The preferable type of the imidizing accelerator herein includes the secondary or tertiary amines with skeletons of picoline, quinolone, isoquinoline and pyridine, and amino acid with alkoxycarbonyl group. Preferably, the tertiary amine is used as the amine as aforementioned. Preferably, butoxycarbonyl group is used as the alkoxycarbonyl group of the amino acid. Preferably, the amino acid includes two or more alkoxycarbonyl groups, or fluorene skeleton.

If polyamic acid ester is used as the first material to be optically aligned, preferably, two of four R2s shown in the chemical formula 1 are methyl groups, and the other two are hydrogen. It is more preferable to take the structure as expressed by the chemical formula 5. The R3 and R4 of the structure expressed by the chemical formula 5 have independent 1-8C alkyl groups.

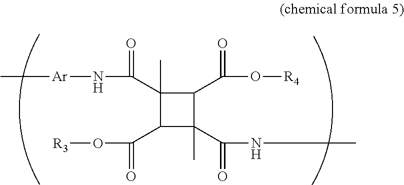

Preferably, polyamic acid or polyamic acid ester has diamine as precursor. The structure of the diamine (first diamine) as the precursor of polyamic acid ester is not specifically limited. It is preferable to use the diamine having aromatic ring but no nitrogen atom except the one in the two amino groups, fluorine atom, and oxygen atom. It is more preferable to use diamine with the structure expressed by the chemical formula 6. The R5 and R6 of the formula are independent hydrogen or <3C alkyl group, respectively.

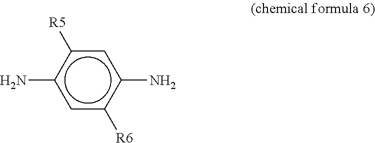

Use of the diamine as described above will lower polarity of polyamic acid ester. Upon application of a mixture of the first material as polyamic acid ester and the second material onto the TFT substrate 100, the first material is likely to be located at the side of the liquid crystal layer 300. This makes it possible to form the alignment film with good property even if the ratio of the first material in the mixture material is reduced.

Meanwhile, the structure of the diamine (second diamine) as the precursor of polemic acid is not necessarily limited. Preferably, the diamine includes nitrogen atom except the one in the two amino groups, fluorine atom, or oxygen atom. Use of the diamine having each of those elements as main skeleton makes polarity of polyamic acid ester high. Upon application of a mixture of the first material and the second material as polyamic acid onto the TFT substrate 100, the second material is likely to be located at the side of the TFT substrate 100. This makes it possible to form the alignment film with good property even if the ratio of the first material in the mixture is reduced.

In the liquid crystal display device according to the present invention, the negative type liquid crystal is used for optical alignment so as to prevent the display unevenness or flickering in spite of the low frequency driving.

What is claimed is:

1. A liquid crystal display device including liquid crystal between a first substrate provided with an alignment film and a second substrate provided with an alignment film, wherein:
the liquid crystal has negative dielectric anisotropy, an absolute value of which is equal to or smaller than 5;
the alignment film is subjected to a polarized UV optical alignment process;
the alignment film includes a first film that is optically aligned to have alignment property, located at a side in contact with the liquid crystal, and a second film that located at a side of the first or the second substrate;
the alignment film is formed by applying a mixture of a first material for forming the first film and a second material for forming the second film to the first substrate or the second substrate; and
the first material accounts for 10 wt. % or more and less than 40 wt. % of a total weight of the first material and the second material.

2. The liquid crystal display device according to claim 1, wherein the first material is polyamic acid ester expressed by a chemical formula 1, and the second material contains polyamic acid; 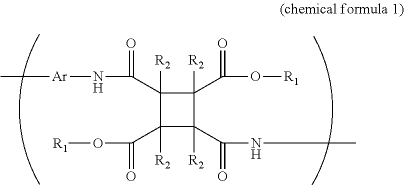
where R1 denotes independent 1-8C alkyl groups, and R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0,1,2) or alkynyl group (—(CH₂)m-C≡CH, m=0,1,2), and Ar denotes aromatic compound.

3. The liquid crystal display device according to claim 1, wherein:
the first material is polyamic acid ester;
the polyamic acid ester is formed by a first diamine as a precursor; and
a chemical structure of the first diamine contains an aromatic ring but does not contain nitrogen atom except the one in two amino groups, fluorine atom, and oxygen atom.

4. The liquid crystal display device according to claim 2, wherein:
the first material is polyamic acid ester;
the polyamic acid ester is formed by a first diamine as a precursor; and
a chemical structure of the first diamine contains an aromatic ring but does not contain nitrogen atom except the one in two amino groups, fluorine atom, and oxygen atom.

5. The liquid crystal display device according to claim 1, wherein:
the second material is polyamic acid;
the polyamic acid is formed by a second diamine as a precursor; and
a chemical structure of the second diamine contains nitrogen atom except the one in two amino groups, fluorine atom, or oxygen atom.

6. The liquid crystal display device according to claim 2, wherein:
the second material is polyamic acid;
the polyamic acid is formed by a second diamine as a precursor; and
a chemical structure of the second diamine contains nitrogen atom except the one in two amino groups, fluorine atom, or oxygen atom.

7. The liquid crystal display device according to claim 1, wherein:
the mixture contains an imidizing accelerator; and
a chemical structure of the imidizing accelerator contains secondary or tertiary amines with picoline, quinolone, isoquinoline or pyridine skeleton, or amino acid with alkoxycarbonyl group.

8. The liquid crystal display device according to claim 2, wherein:
the mixture contains an imidizing accelerator; and
a chemical structure of the imidizing accelerator contains secondary or tertiary amines with picoline, quinolone, isoquinoline or pyridine skeleton, or amino acid with alkoxycarbonyl group.

9. The liquid crystal display device according to claim 1, wherein the material for forming the alignment film further contains a silane coupling agent expressed by a chemical formula 3 or 4.

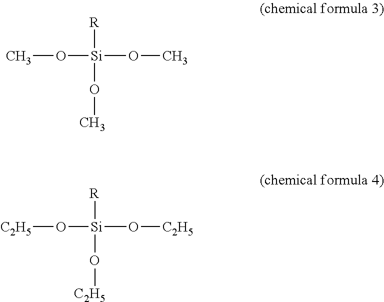

10. The liquid crystal display device according to claim 2, wherein the material for forming the alignment film further contains a silane coupling agent expressed by a chemical formula 3 or 4.

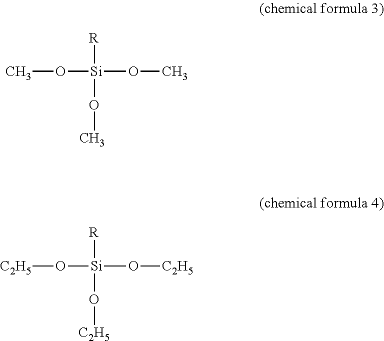

11. The liquid crystal display device according to claim 1, wherein the liquid crystal is driven at frequency equal to or lower than 20 kHz.

12. The liquid crystal display device according to claim 2, wherein the liquid crystal is driven at frequency equal to or lower than 20 kHz.

13. An alignment film material used for forming an alignment film of a liquid crystal display device, wherein:
the alignment film material is a mixture of a first material and a second material;
the first material is polyamic acid ester expressed by a chemical formula 1, and the second material is polyamic acid expressed by a chemical formula 2; and
the first material accounts for 10 wt. % or more and less than 40 wt. % of a total weight of the first material and the second material; 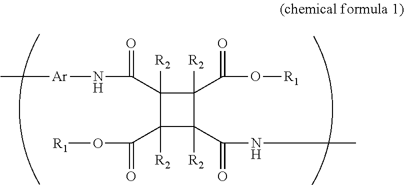
where R1 denotes independent 1-8C alkyl groups, and R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0,1,2) or alkynyl group (—(CH₂)m-C≡CH, m=0,1,2), and Ar denotes aromatic compound; 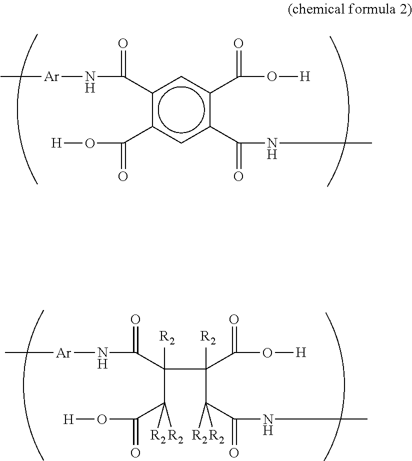
where R2 denotes independent hydrogen atom, fluorine atom, chlorine atom, bromine atom, phenyl group, 1-6C alkyl group, 1-6C alkoxy group, vinyl group (—(CH₂)m-CH═CH₂, m=0, 1,2) or alkynyl group (—(CH₂)m-C≡CH, m=0,1,2), and Ar denotes aromatic compound.

14. The alignment film material for liquid crystal according to claim 13, wherein:
the polyamic acid ester is formed by a first diamine as a precursor;
a chemical structure of the first diamine contains an aromatic ring but does not contain nitrogen atom except the one in two amino groups, fluorine atom, and oxygen atom.

15. The alignment film material for liquid crystal according to claim 13, wherein:
the polyamic acid is formed by a second diamine as a precursor; and
a chemical structure of the second diamine contains nitrogen atom except the one in two amino groups, fluorine atom, or oxygen atom.

16. The alignment film material for liquid crystal according to claim 14, wherein:
the polyamic acid is formed by a second diamine as a precursor; and
a chemical structure of the second diamine contains nitrogen atom except the one in two amino groups, fluorine atom, or oxygen atom.

17. The alignment film material for liquid crystal according to claim 13, wherein:
an imidizing accelerator is contained; and
a chemical structure of the imidizing accelerator contains secondary or tertiary amines with picoline, quinolone, isoquinoline or pyridine skeleton, or amino acid with alkoxycarbonyl group.

18. The alignment film material for liquid crystal according to claim 14, wherein:
an imidizing accelerator is contained; and
a chemical structure of the imidizing accelerator contains secondary or tertiary amines with picoline, quinolone, isoquinoline or pyridine skeleton, or amino acid with alkoxycarbonyl group.

19. The alignment film material for liquid crystal according to claim 13, wherein the alignment film material further contains a silane coupling agent expressed by a chemical formula 3 or 4.

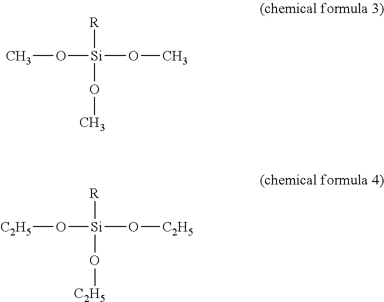

20. The alignment film material for liquid crystal according to claim 14, wherein the alignment film material further contains a silane coupling agent expressed by a chemical formula 3 or 4. [chemical structure]
